(19) United States
(12) Patent Application Publication
(10) Pub. No.: US 2024/0345387 A1
(43) Pub. Date: Oct. 17, 2024

(54) AN OPTICAL ANTENNA FOR OPTICAL PHASED ANTENNA ARRAYS

(71) Applicants: UNIVERSITEIT GENT, Gent (BE); IMEC VZW, Leuven (BE)

(72) Inventors: Wim BOGAERTS, Melle (BE); Lukas VAN ISEGHEM, Gent (BE)

(21) Appl. No.: 18/683,156

(22) PCT Filed: Aug. 9, 2022
(86) PCT No.: PCT/EP2022/072376

§ 371 Date: Feb. 12, 2024

(30) Foreign Application Priority Data
Aug. 12, 2021 (EP) 21191104.5

(51) Int. Cl. G02B 27/00; G02B 6/34

(52) U.S. Cl. CPC G02B 27/0087; G02B 6/34

(57) ABSTRACT

An optical antenna includes a waveguide structure having a waveguide core and a waveguide fin intersecting substantially under a right angle. A height of the waveguide fin is larger than a height of the waveguide core; and the width of the waveguide core is equal to or larger than twice a height of the waveguide core; and the height of the waveguide fin is equal to or larger than twice a width of the waveguide fin. The waveguide fin is off centered with respect to the waveguide core at an offset, thereby forming an optical antenna configured to leak radiation in a radiation direction. Embodiments relate to an optical phased antenna array comprising a plurality of such optical antennas arranged in an array configuration.

### TECHNICAL FIELD

The present disclosure relates to an optical antenna and, more specifically, to an optical antenna suitable for optical phased antenna arrays.

### BACKGROUND

Optical phased arrays are commonly used in various industrial applications such as Light Detection and Ranging, LiDAR, systems, and optical communications for transmitting or receiving light. An optical phased-array transmitter includes a light source such as a laser, a power splitter, tunable phase shifters, and an array of radiating or antenna elements. Using optical waveguide technology makes it possible to implement these optical functions on the surface of one or more chip substrates. The output light of the light source is split into several branches using the power splitter. Each branch is then fed to a tunable phase shifter which phase-shifts the light. The phase-shifted light is input to a radiating element such as an optical antenna element that couples the light from the on-chip waveguide into free space. The light radiated by the optical antenna elements is combined in the far-field to form the far-field profile of the optical phased array. By adjusting the relative phase shift or the phase delay between the optical antenna elements, a light beam can be formed and steered.

In some applications, such as in the automotive industry, an optical phased array needs to provide both a wide steering angle along the horizontal direction range of about fifty degrees towards the left and right, as well as a long beam projection in the range of hundreds of meters, for example. To do so, the total area of the antenna array needs to be in range of centimeters which requires in the case of a one-dimensional antenna array that its optical antenna elements to be not only densely packed together but each of them needs to be sufficiently long so that the optical phased array can emit a narrow, preferably, collimated beam with a beam waist in the range of centimeters, i.e., above 1 cm, and a beam projection distance in the range of hundreds of meters, i.e., above 100 m.

Providing an optical phased array satisfying the above requirements is very challenging as currently no technique allows both packing the antenna elements sufficiently dense together and manufacturing the antenna elements to provide both a wide-steering angle and a long projection. Recent research proposes a wide two-dimensional beam steering solution in which the two-dimensional beam steering is provided by a one-dimensional optical phased array employing a number of densely packed wavelength-dependent antenna elements provided with diffraction gratings, in which tunable phase shifters provide beam steering in one direction, e.g., the x-axis, and the diffraction gratings provide beam steering in the other direction, e.g., the y-axis. The use of such diffraction gratings to couple the light from the on-chip waveguide to the free space, however, prohibits the scale of this array to provide long beam projections as the diffraction gratings cannot be manufactured with sufficient precision using high-contrast materials which allow dense packing of the antenna elements in the optical phased array.

### SUMMARY

It is an object of embodiments of the present disclosure to provide an antenna element overcoming the above constraints. It is a further object of embodiments of the present disclosure to provide an integrated antenna element overcoming the above constraints.

This object is achieved, according to a first example aspect of the present disclosure, by an optical antenna. In particular, the optical antenna comprises a waveguide structure formed on a substrate. The waveguide structure comprises a waveguide core and a waveguide fin. The waveguide core and the waveguide fin can be, for example, made of the same material thus forming a unified waveguide structure. Alternatively, the waveguide core and the waveguide fin can be, for example, made of the different materials. For example, the waveguide core may comprise silicon with a refractive index of 3.45 while the waveguide fin comprises silicon nitride with a refractive index of 2.1. Alternatively, the waveguide core may comprise silicon nitride with a refractive index of 2.1 while the waveguide fin comprises silicon with a refractive index of 3.45. The waveguide core and the waveguide fin are both elongated three-dimensional structures such as an orthogonal or rectangular parallelepiped with its faces characterized with a high aspect ratio. Alternatively, the waveguide fin and/or the waveguide core can have non-rectangular cross-sections while still complying with the aspect ratios described in the present disclosure. To form the waveguide structure, the waveguide fin is placed on top of the waveguide core at a right angle. Alternatively, to form the waveguide structure, the waveguide fin can be placed underneath the waveguide core at a right angle and then radiate the light towards the bottom, i.e. essentially turning the waveguide structure upside down. More specifically, the waveguide fin, as its name suggests, is placed with its longer, narrower surface on top of the longer, wider surface of the waveguide core, thus forming a waveguide structure on the substrate with an upside-down T-shaped cross-section. This requires that both the waveguide core and the waveguide fin have at least the same length in the antenna. The thus formed waveguide structure has a rib or a vertical section formed by the waveguide fin and a flange, or a horizontal section formed by the waveguide core. A height of the waveguide fin is larger than a height of the waveguide core. The waveguide core demonstrates the following aspect ratio: the width of the waveguide core is equal to or larger than twice a height of the waveguide core. The waveguide fin demonstrates the following aspect ratio: the height of the waveguide fin is equal to or larger than twice a width of the waveguide fin. Further, the waveguide fin is placed on top of the waveguide core in such a way that a center axis of the waveguide fin is off-centered with respect to a center axis of the waveguide core at a certain offset. In other words, there is an offset between the center axis of the waveguide core and the center axis of the waveguide fin. The offset breaks the symmetry in the waveguide structure in the horizontal direction. In other words, the offset breaks the mirror symmetry across a vertical plane running along the centerline of the waveguide core. This asymmetry creates a non-zero field overlap which couples the guided mode to the radiating mode of the waveguide structure in the vertical direction. By doing so, an optical antenna is formed which leaks radiation in the vertical direction, i.e., away from the plane of the substrate and through the top of the waveguide fin with a radiation leakage that is substantially defined by the offset. Such an optical antenna can be easily constructed without using any complex, highly controlled manufacturing processes such as high precision lithography. In other words, such an integrated optical antenna can be easily manufactured using current large-scale lithographic techniques. Further, constructing an optical antenna in this way allows designing optical antennas with leakage profiles adapted to a wide variety of applications such as LiDAR solutions for self-driving cars or virtual/artificial reality and optical data communication solutions for chip-to-chip data communication.

Preferably, the offset between the center axes of the waveguide core and the waveguide fin is varied along the length of the waveguide core. As mentioned above, the offset substantially defines the radiation leakage. Thus, varying the offset along the length of the waveguide core allows controlling the radiation leakage, i.e., the rate of the radiation leakage, along the length of the optical antenna, which in turn defines the profile of the optical beam generated by the optical antenna. Contrary to conventional solutions, where the leakage rate is controlled by means of complex sub-wavelength structures such as apodised diffraction gratings requiring highly controlled manufacturing processes, herein the rate of the radiation leakage is controlled by simply varying the offset along the length of the optical antenna. Advantageously, obtaining an optical beam with a desired beam profile does not require fast varying offset, i.e., the offset does not need to change rapidly or abruptly along the length of the optical antenna, and no discontinuities are needed. In other words, the offset does change significantly along the length of the antenna, but because the antenna is long, is does not change rapidly. Thus, an offset varying slowly along the length of the optical antenna is sufficient to provide the required control over the leakage rate, thus allowing using current large-scale lithographic techniques as detailed above to manufacture the optical antenna. Although these conventional manufacturing processes may be subject to higher process variations in comparison to more complex, highly controlled counterparts, variations in the offset caused by process variations are tolerable.

Preferably, the waveguide core has a substantially rectangular cross-section with a width of its cross-section varying along the length of the waveguide core. Advantageously, varying the width of the rectangular cross-section of the waveguide core along its length allows for a substantial control of the direction of the radiation leakage along the length of the waveguide core. Preferably, the waveguide fin also has a substantially rectangular cross-section with an aspect ratio higher than the aspect ratio of the cross-section of the waveguide core and a width varying along the length of the waveguide fin. Varying the width of the rectangular cross-section of the waveguide fin also allows for a substantial control of the propagation constants of the waveguide modes and, therefore, the direction of the radiation leakage along the length of the waveguide core. In other words, the direction of the radiation leakage can be controlled by varying the width of the cross-section of the waveguide core or by varying the width of the cross-section of the waveguide fin. This allows to control the direction of the leakage radiation by using not one but two control parameters, i.e., the width of the cross-section of the waveguide core and the waveguide fin, respectively. Thus, a higher degree of radiation direction control can be achieved. As a result, the optical antenna can be designed to satisfy the requirements of a wide range of applications.

Advantageously, the asymmetry controlling the leakage rate and, thus, the coupling between the guided mode and the radiation mode of the waveguide structure, can be implemented in any way that controls the asymmetry in the waveguide structure in the horizontal direction and, therefore, the modal overlap between the guided and the radiation modes of the waveguide structure. As a preferred option, the asymmetry can be obtained by varying the offset, i.e., placement of the waveguide fin along the length of the waveguide core and, thus, the optical antenna. In such a case, the distance between the center axis of the waveguide fin with respect to the center axis of the waveguide core is controlled and the dimensions of the cross-sections of both the waveguide core and the waveguide fin are kept the same. As another preferred option, the asymmetry is controlled by varying both the width of the rectangular cross-section of the waveguide core along its length as well as the offset. In such a case, the width profile of the core's cross-section thus acts as an additional control parameter that can be used together with the offset to further control the asymmetry in the waveguide structure. In other words, preferably, the geometry of the waveguide structure is controlled using independent control parameters to adjust both the leakage rate through the asymmetry and modal overlap, and the radiation angle through the propagation constant. Thus, varying both of these control parameters allows precise control over the asymmetry of the waveguide structure and therefore the coupling between the guided mode and the radiation mode of the optical antenna. As a yet another preferred option, the coupling between the guided mode and the radiation more of the optical antenna can be obtained by varying both the width of the rectangular cross-section of the waveguide fin along its length as well as the offset. The width profile of the fin's cross-section thus can also act as an additional control parameter that can be used together with the offset to further control the asymmetry in the waveguide structure. In other words, the asymmetry of the waveguide structure and, therefore, the leakage rate and the leakage direction along the length of the optical antenna, is preferably controlled by varying any one of these three control parameters, i.e., the width of the core's cross-section, the width of the fin's cross-section, and their position relative to one another, or any combination thereof.

Advantageously, the optical antenna can be configured to generate an optical beam with a beam profile which can be defined by the leakage rate and the leakage direction along the length of the waveguide core. Preferably, the optical antenna is configured to generate an optical beam with a substantially Gaussian beam profile. This can be achieved by for example varying the leakage rate along the length of the waveguide core. Preferably, the leakage rate is varied from a very weak, i.e., zero, to a very strong, i.e., maximum achievable. This can be done by for example solely using the offset as a control parameter to define the profile of the leakage rate along the length of the optical antenna such that the radiated optical beam has a Gaussian profile. More preferably, the optical antenna is configured to generate an optical beam with a collimated and substantially Gaussian beam profile. This can be achieved by for example varying the leakage rate along the length of the waveguide core while maintaining the leakage direction substantially uniform along the length of the waveguide core. To do so, in addition to the offset, the width of the cross-section of the waveguide core and/or the width of the cross-section of the waveguide fin are used as control parameters to maintain the propagation constant along the length of the waveguide core, i.e., to maintain the radiation angle along the length of the waveguide core constant. As a result, an optical antenna can be designed to radiate an optical beam with a required beam profile, e.g., with a required beam distribution, a beam waist, and a beam projection distance.

Advantageously, the optical antenna can generate an optical beam with a beam profile along the length of the waveguide core characterized with a beam waist in the range of centimeters and a beam projection distance in the range of hundreds of meters. For example, the optical antenna can generate an optical beam with a beam waist in the range of 10-30 mm and a beam projection distance in the range of 100-300 m. Furthermore, the optical antenna can generate an optical beam with the above characteristics which can be steered within a range of hundred degrees. Such beam profiles allow the optical antenna to be used in a wide variety of applications such as automotive or virtual/artificial reality applications, and many others. For automotive applications, a beam profile with a beam waist of 30 mm and a beam projection distance of 200 m to 300 m allows detection of a surrounding object within a radius of 200 m to 300 m.

More advantageously, the beam profile of the optical antenna is wavelength dependent. In other words, a specific beam profile for a specific wavelength can be designed by varying any one of or a combination of the width of the cross-section of the waveguide core, the width of the cross-section of the waveguide fin, and their position relative to one another. Thus, by carefully varying any one of or a combination of the above-mentioned control parameters, a beam profile with the required properties can be obtained thus making the optical antenna capable of generating an optical beam with strict beam profile requirements.

Preferably, the waveguide fin is provided with a diffraction grating. A diffraction grating is a type of optical device comprising a pattern of grooves, channels, or cavities that is configured to couple the radiation from the waveguide structure and, more specifically, from the waveguide fin into free space. The diffraction grating is a one-dimensional or linear grating, i.e., a diffraction grating characterized with a pattern of grooves, channels, or cavities formed in one direction. Further, the diffraction grating can be optimized to perform optimal for the TM polarization. That is, the pattern of grooves, channels, or cavities and/or the dimensions of the grooves, channels, or cavities, can be optimized for the required polarization. Preferably, the diffraction grating is periodic or uniform. In other words, the pattern of grooves, channels, or cavities is periodic or uniform, i.e., the grooves, channels, or cavities are spaced equally apart. Further, as the leakage rate and, hence, the beam profile, is controlled by simply controlling the offset, this uniform diffraction grating herein can be manufactured without the need carefully designed variations of the period and fill factor and using current large-scale lithographic processes with process conditions optimized for maximum uniformity. Accordingly, highly controlled processes such as high precision lithography and similar, for producing the diffraction grating with complex patterns, i.e., apodised gratings, are avoided. Further, the diffraction grating is preferably made of material with a refractive index contrast of above 10%. For example, the diffraction grating can be made of materials such as silicon, silicon nitride, silicon oxynitride, silicon dioxide, semiconductors, and alumina. Using materials with such a refractive index contrast allows achieving a strong diffraction grating assuring coupling of all leaked radiation into free space. Alternatively, instead of using a diffraction grating with the above-mentioned characteristics, a refractive optical element can be used instead. For example, any conventional refractive optical element capable of providing the same functionality as the diffraction grating can be used instead. An example of such refractive optical element is a tilted interface such as a prism. Again, highly controlled manufacturing processes for manufacturing the refractive optical element are avoided, as its sole purpose is to couple the radiation into free space. The refractive optical element is typically placed on top of the waveguide fin after the waveguide structure is manufactured.

Preferably, the waveguide structure is a dielectric or semiconductor waveguide structure. In other words, the waveguide structure, i.e., the waveguide core and the waveguide fin can be made of a dielectric material such as silicon nitride, SiN, or a semiconductor material such as silicon, Si, while the substrate can be made of other semiconductor or dielectric materials such as silicon, silicon dioxide, and indium phosphide, InP. More preferably, the waveguide core is made of a material that has a refractive index contrast of above 10% with respect to surrounding materials. In other words, the waveguide core can be made of silicon or silicon nitride while the waveguide fin and the substrate can be made of silicon dioxide, respectively. Doing so assures that the waveguide structure can be made sufficiently narrow allowing them to be spaced together in a periodic array, and that the modal overlap between the guided TE mode and radiating TM mode can be sufficiently engineered to obtain a high radiation leakage rate.

Preferably, the width of the waveguide fin is substantially equal to or larger than the height of the waveguide core.

Preferably, an optical thickness of the waveguide fin is larger than an optical thickness of the waveguide core. An optical thickness of the waveguide fin corresponds approximately to a product of the width of the waveguide fin by a refractive index of the waveguide fin. An optical thickness of the waveguide core corresponds approximately to a product of the thickness of the waveguide core by a refractive index of the waveguide core. For example, when the waveguide core comprises a three-layer slab, and the fin comprises a three-layer slab on its side, the effective index of the waveguide fin should be higher than the effective index of the waveguide core, both for the TE mode of the respective slab, with the E-field pointing out of plane.

According to a second example aspect, an optical phased antenna array is disclosed. In particular, the optical phase antenna array comprises a plurality of optical antennas according to the first example aspect. Such an optical phased antenna array can provide one or more of the above-mentioned advantages. The optical antennas can for example be arranged to form a one-dimensional array with the optical antennas spaced less than 4 μm apart. Preferably, the optical antennas are spaced around 3 μm apart to enable the generation of a beam with a desired beam profile which can be steered in the x-direction with a steering angle in the range above hundred degrees. If the stacked optical antennas are designed to be wavelength dependent, then the emitted beam can be also steered in y-direction by controlling the wavelength of the input light. Stacking around 10000 of such optical antennas together in a one-dimensional array result in an optical phased array capable of emitting a beam with a beam waist of 30 mm wide in the x-direction.

### BRIEF DESCRIPTION OF THE DRAWINGS

Some example embodiments will now be described with reference to the accompanying drawings.

FIG. 1A shows a schematic drawing of a waveguide structure according to an embodiment of the present disclosure;

FIG. 1B shows an example of the coupling between the guided mode and the radiating mode for the waveguide structure of FIG. 1A;

FIG. 2A shows another schematic drawing of a waveguide structure according to an embodiment of the present disclosure;

FIG. 2B shows a top view of an optical antenna employing the waveguide structure of FIG. 2A according to an embodiment of the present disclosure;

FIG. 2C shows a side view of the optical antenna employing the waveguide structure of FIG. 2A according to an embodiment of the present disclosure; and

FIG. 3A shows a top view of an optical antenna according to another embodiment of the present disclosure;

FIG. 3B shows a top view of an optical antenna according to yet another embodiment of the present disclosure;

FIG. 4 shows an example of a beam profile radiated by an optical antenna according to the present disclosure;

FIG. 5A shows an example of simulated effective index map and leakage rate in function of the offset between the waveguide core and the waveguide fine and the cross-section width of the waveguide core according to an embodiment of the present disclosure;

FIG. 5B shows plots illustrating the relationship between the cross-section width of the waveguide core and the offset for a selected effective index and the relationship between the leakage rate and the offset for the selected effective index according to an embodiment of the present disclosure;

FIG. 5C shows an example leakage profile for the waveguide structure according to an embodiment of the present disclosure;

FIG. 5D shows an example of the radiation profile for the waveguide structure according to an embodiment of the present disclosure;

FIG. 6A shows an example of a Gaussian beam profile for an optical antenna according to an embodiment of the present disclosure;

FIG. 6B shows an example of a radiation profile for an optical antenna according to an embodiment of the present disclosure;

FIG. 6C shows an example of a leakage rate profile for providing the beam profile of FIG. 6A; and

FIG. 7 shows another schematic drawing of a waveguide structure according to an embodiment of the present disclosure.

### DETAILED DESCRIPTION OF EMBODIMENT(S)

In the context of the present disclosure, the term “optical antenna” and “waveguide structure” refer to an optical device capable of generating or receiving light or radiation. In the context of the present disclosure, the terms “radiation” and “light” are used for indicating electromagnetic radiation with a wavelength in a suitable range, i.e., electromagnetic radiation with a wavelength that is not absorbed by the materials used such as the material of the waveguide structure, for example, electromagnetic radiation with a wavelength between 0.3 μm and 2 μm, e.g., near-infrared radiation, NIR, or short wave infrared radiation, SWIR.

Light Detection and Ranging, LiDAR, systems are useful in a wide variety of applications such as self-driving cars, virtual or artificial reality, where a focused beam of light is used to probe the surroundings to map the environment or to track the movement of various objects therein. One of the challenges in developing LiDAR systems is the requirement for a narrow, clean beam and, in some cases, a collimated beam. In other words, it is required that the beam has little to no sidelobes so that most of the power is in the main beam lobe and not scattered in other directions. In addition to that, many applications using LiDAR need to have a large enough range to be useful. In forward-looking automotive LiDAR solutions, for example, objects in the surrounding environment at a distance of at least 200 m need to be detected. This means the Rayleigh range of the beam zᵣ>200 m, and the roundtrip distance s=2.zᵣ. For this range, the beam ‘waist’ or the beam diameter which is given as 2w₀ needs to be in the order of 30 mm. This follows from the Rayleigh range zᵣ of a Gaussian beam with a wavelength λ and a roundtrip distance s that the beam waist 2w₀ should be:

$$s = 2 {z}_{r} = \frac{π {w}_{0}^{2}}{λ}$$

$$2 {w}_{0} = 2 \sqrt{2} \sqrt{\frac{200 * 1.55 * 1 {0}^{- 6}}{π}} m \approx 3 * 10 mm ( \approx 3 {w}_{0} )$$

$$2 {w}_{0} = 30 mm$$

In addition to that stringent beam waist requirement, the beam direction needs to be steered within a wide-angle range, often within around fifty degrees towards left and right in the x-direction and also in the range of 10-20 degrees in the y-direction. The range of steering angle of 10-20 degrees in the y-direction is sufficient for automotive industry applications. One way to achieve this is with a periodic array of optical antennas, i.e., an optical phased array, OPA. The optical antenna array is integrated on a chip which can additionally comprise electronics for controlling the operation of the antennas on the chip. Each antenna on the chip emits light and the electronics on the chip control the relative phase between the antennas. When all the antennas are in phase, the antenna array behaves as one large antenna. When all the antennas are operated with a fixed phase delay between adjacent antennas, the resulting emitted beam is tilted. Thus, by controlling the relative phase between the antennas the resulting beam can be steered in x-direction. If the antennas are designed to be wavelength dependent, then the emitted beam can be also steered in y-direction by controlling the wavelength of the input light. For best efficiency and a wide steering angle in the x-direction, however, the individual antennas need to be closely spaced and have a large fill factor.

The present disclosure thus relates to an optical antenna capable of generating a clean, long optical beam for scanning the surroundings at a distance in the range of hundreds of meters, allowing the optical antennas to be densely packed into an optical antenna array to enable wide-steering angles. The present disclosure discloses a novel approach of creating an optical antenna that avoids using difficult to manufacture complex sub-wavelength structures. Instead, only slowly changing geometries are used in combination with a long uniform grating, creating features that are much more feasible to fabricate with current large-scale lithographic techniques as the requirement for high precision lithography processes is eliminated.

The proposed optical antenna employs the concept of a so-called continuously “leaky” antenna to make an optical antenna with a controlled radiation leakage along the length of the optical antenna. This is achieved by adapting the known principle of lateral leakage to obtain a vertical leakage or an out-of-plane radiation leakage. To do so, the optical antenna according to the present disclosure is designed as a waveguide structure that radiates or leaks radiation power away from the waveguide guided mode and along the waveguide propagation direction at a controllable rate. Controlling the leakage rate of the radiation in the propagation direction allows obtaining any desired radiation power leakage profile by the waveguide structure. Otherwise said, controlling the leakage rate in the propagation direction allows controlling the profile of the optical beam radiated by the optical antenna. The control of the leakage rate is herein obtained by adapting the geometry of the waveguide structure as will be now detailed with reference to the figures. For consistency, the parts of the waveguide structure which are identical in the various figures are denoted by identical reference signs.

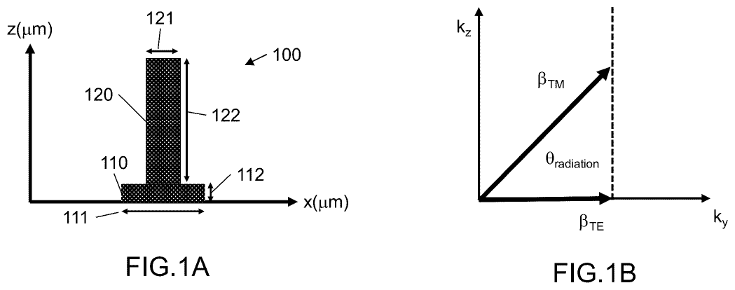

FIG. 1A shows a schematic of a waveguide structure 100 according to an example embodiment of the present disclosure. The waveguide structure 100 comprises a waveguide core 110 and a waveguide fin 120. Each of the waveguide core and the waveguide fin comprises an elongated three-dimensional structure such as an orthogonal or rectangular parallelepiped with faces characterized with a high aspect ratio. As shown in the figure, the width 111 of the waveguide core 110 is bigger than its height 112. Similarly, the width 121 of the waveguide fin 120 is smaller than its height 122. Although, not visible in this figure, the waveguide core 110 and the waveguide fin 120 have the same length along the y-direction, out of the plane of the figure, which is much larger than the width of the waveguide core along the x-direction and the height of the waveguide fin along z-direction, respectively. To form the waveguide structure 100, the waveguide fin 120 is placed on top of the waveguide core 110 at a right angle. More specifically, the waveguide fin 120, as its name suggests, is placed with its longer, narrower surface on top of the longer, wider surface of the waveguide core 120, thus forming a waveguide structure with an upside-down T-type of a cross-section. The thus formed waveguide structure 120 has a web or a vertical section formed by the waveguide fin 120 and a flange or a horizontal section formed by the waveguide core 110 with the width of the waveguide fin 120, w_{fin}, defining the width of the optical antenna, wₐₙₜ, i.e., w_{fin}=wₐₙₜ, and the length of the waveguide core or the waveguide fin along the y-direction defining its length, Lₐₙₜ, L_{core}=L_{fin}=Lₐₙₜ.

The waveguide structure 100 has a semi-guided transverse electric, TE, waveguide mode, β_{TE}, which couples to a radiating transverse magnetic, TM, waveguide mode, β_{TM}, in the vertical direction as shown in FIG. 1B. The coupling between the guided waveguide mode and the radiating mode along the length of the waveguide structure defines the leakage rate of the radiation of the optical antenna along its length, i.e., how much radiation leaks from the semi-guided waveguide mode to the radiation mode. The magnitude of β_{TM} and β_{TE} vectors is determined by the dimensions and the aspect ratio of the waveguide core and the waveguide fin and when β_{TM}>β_{TE}, their relative magnitudes determined the angle, θ_{radiation}, of the leaked radiation. Further, the two propagation vectors β_{TM} and β_{TE} need to have the same k_{y} component. In this figure, the magnitude of these vectors indicate that the geometry of the waveguide core and the waveguide fin is chosen such that the width of the fin is wider than the thickness of the waveguide core, i.e., w_{fin}>t_{core}, where in this case it is assumed that the core and fin consist of materials with a similar refractive index. The strength of the coupling between the semi-guided TE mode and the leaking TM mode is determined by the electrical field overlap. When the structure is symmetric along the x-direction, this overlap is zero and there is no leakage.

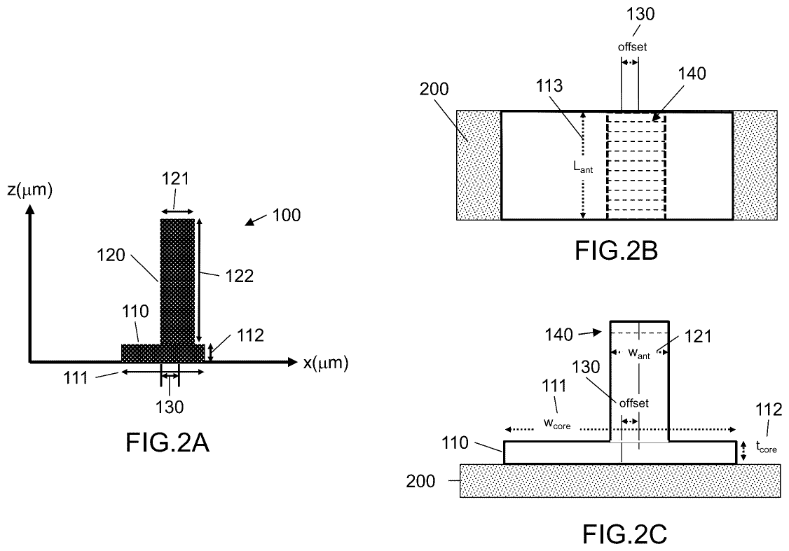

Placing the waveguide fin 120 at an offset 130, i.e., offset, with respect to the waveguide core 110, as shown in FIG. 2A, adds an asymmetry to the waveguide structure 100. In this figure, offset 130 is shown as the distance between the center axis of the waveguide core and the waveguide fin. A waveguide structure 100 with such geometry can be fabricated in silicon, Si, or silicon nitride, SiN photonics using current large-scale photolithographic techniques with both the waveguide core 110 and the waveguide fin 120 made of the same material, i.e., Si or SiN, respectively, or materials with a similar refractive index. An example of such a waveguide structure 100 is shown in FIG. 2B and FIG. 2C, showing a top view and a front view of the waveguide structure 100 placed on top of a silicon substrate 200, respectively. A height 122 of the waveguide fin 120 is larger than a height 112 of the waveguide core 110. The waveguide core 110 demonstrates the following aspect ratio: the width 111 of the waveguide core 110 is equal to or larger than twice a height 112 of the waveguide core 110. The waveguide fin 120 demonstrates the following aspect ratio: the height 122 of the waveguide fin 120 is equal to or larger than twice a width 121 of the waveguide fin 120. To assure the coupled radiation power leaks into free space, the waveguide fin can optionally be provided with a diffraction grating 140 or a refractive optical element as shown in FIG. 2A and FIG. 2B, i.e., the diffraction grating 140 is provided on the top of the fin 120. The diffraction grating is an optical device that comprises a pattern of grooves, channels, or cavities. In this figure, the diffraction grating comprises grooves that are arranged in one direction. Such a grating is commonly referred to as a one-dimensional or linear grating. Advantageously, herein, the purpose of this linear grating is mere coupling the leaked radiation into free space, the diffraction grating need not be apodised, i.e., the linear diffraction grating can comprise a pattern of uniformly distributed grooves.

The asymmetry in the waveguide structure 100 introduced by off-centering the waveguide fin 120 with respect to the waveguide core 110, affects the coupling between the semi-guided TE mode and the radiating TM mode and, therefore, how much radiation leaks into the waveguide fin. A center axis of the waveguide fin is in offset with respect to a center axis of the waveguide core. The leakage mechanism relates to the hybrid nature of the guided TE mode in the waveguide core 110. Because of the high index contrast of the waveguide core 110 with respect to the surrounding material, i.e., the substrate 200, there is a non-negligible electrical field component along the direction of propagation, Ey, allowing the coupling to the TM mode in the waveguide fin 120 to occur. When the waveguide fin 120 is sufficiently wide, i.e., typically w_{fin}>t_{core}, it will result in β_{TM}>β_{TE}, which means that phase matching occurs with the leaking TM mode. For example, for a silicon nitride waveguide we could have a TE mode with an effective refractive index of ˜1.57, and a radiating TM mode with an effective refractive index of ˜1.74. This mechanism is similar to the phenomenon of lateral leakage but with the mode polarizations reversed.

The anti-symmetric nature of the electrical field component along the z-direction, i.e., Ez component in the semi-guided TE waveguide mode in the waveguide core 110, leads to the cancelation of the coupled radiation, i.e., anti-phase, when the waveguide structure 100 is symmetric along the x-direction, i.e., when the waveguide fin 120 is placed along the center axis of the waveguide core. Breaking this symmetry in the waveguide structure causes this cancellation to disappear and the modes start to couple to each other. The mode coupling increases as the location of the overlap, i.e., the corners where the fin and the waveguide core meet, are positioned more asymmetrically from the center of the waveguide core. This asymmetry results in less cancellation and thus an increasing modal overlap between the semi-guided TE mode and radiating TM mode. This symmetry-breaking mechanism for tuning the leakage rate is fundamentally different from the one commonly applied in lateral leakage. The lateral leakage uses interference between two leaking edges to control the leakage rate and adjusting the dimensions of the waveguide to achieve constructive or destructive interference, leading to so-called ‘magic’ or ‘anti-magic’ widths. In contrast, herein, the symmetry-breaking to tune the leakage rate is achieved by off-centering the single waveguide fin as described above.

Asymmetry in the waveguide structure 100 can be also achieved by controlling the width 111 of the cross-section of the waveguide core 110, w_{core}, as well as the width 121 of the cross-section of the waveguide fin 120, i.e., w_{fin}. Further, the thickness 112 of the waveguide core 110, i.e., t_{core}, can also be used to control the leakage rate. Thus, the offset, the width of the cross-section of the waveguide core and the waveguide fin, respectively, and the thickness of the waveguide core 110, act as control parameters that can be used individually or in any combination to control the asymmetry in the waveguide structure as detailed further below.

Although, the t_{core} and w_{fin} can be used as control parameters, fabricating a waveguide core with varying thickness and/or fabricating a waveguide fine with a varying cross-section's width is difficult to achieve with current large-scale lithographic techniques. For these reasons, when fabricating the waveguide structure using current large-scale deposition, etching, and lithographic techniques, it is preferred to keep t_{core} and w_{fin} constant and vary the w_{core} and/or the offset.

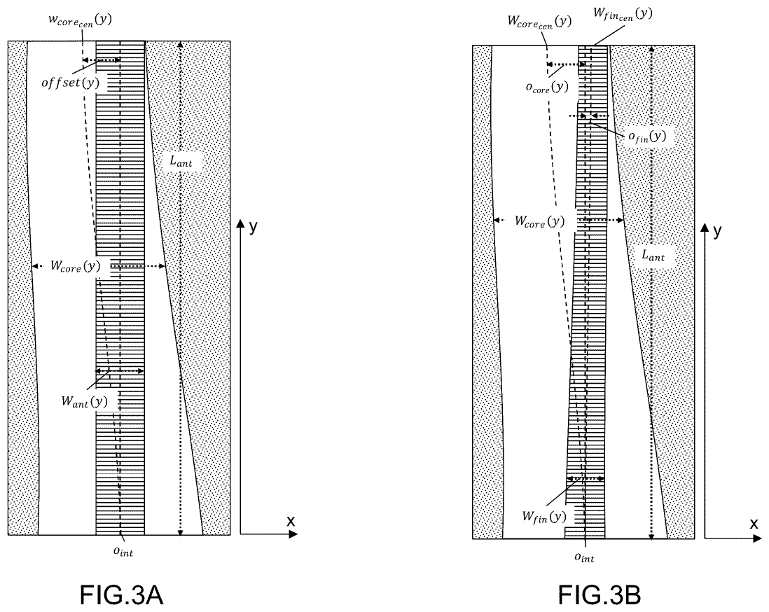

FIG. 3A shows a top view of an example waveguide structure where the leakage rate is controlled by means of the offset control parameter. A height of the waveguide fin is larger than a height of the waveguide core. The waveguide core demonstrates the following aspect ratio: the width of the waveguide core is equal to or larger than twice a height of the waveguide core. The waveguide fin demonstrates the following aspect ratio: the height of the waveguide fin is equal to or larger than twice a width of the waveguide fin. A center axis of the waveguide fin is in offset with respect to a center axis of the waveguide core. As shown in the figure, the offset is varied along the length of the antenna, i.e., offset(y), with the offset gradually increasing from zero to a maximum value. The offset variation is herein achieved by varying both the w_{core} and the center point w_{core}_{_{cen}} of the waveguide core along the length of the antenna, i.e., w_{core}(y)≠const and w_{core}_{_{cen}}(y)≠const. This allows achieving asymmetry while preserving the w_{fin} constant along the length of the antenna, i.e., w_{fin}(y)==const. FIG. 3B shows a top view of another example waveguide structure where the leakage rate is controlled by using the offset, the w_{core} and the w_{fin} as control parameters. As can be seen from the figure, the offset is varied along the length of the antenna, i.e., offset(y), with the offset gradually increasing from zero to a maximum value, with the offset variation being achieved by varying both the w_{core} and the center point w_{core}_{_{cen}} of the waveguide core along the length of the antenna, i.e., w_{core}(y)≠const and w_{core}_{_{cen}}(y)≠const, as in FIG. 3A, and by additionally varying the w_{fin} along the length of the antenna, i.e., w_{fin}≠const.

As described above, the vertical leakage mechanism relies on breaking the symmetry in the waveguide structure. The radiation leakage can be approximated as follows. For all possible values of w_{core} and an offset=0, the result is a symmetric geometry with no loss, i.e., perfect guiding. In a first approximation, the same amount of symmetry breaking will result in an equal loss rate, in other words, it can be assumed that for all configurations when varying both w_{core} and the offset the loss rate will be similar for values with the same relative offset:

$${offset}_{r e l} = \frac{offset}{\frac{1}{2} {w}_{core} - {w}_{fin}} .$$

This means the main control parameter affecting the leakage rate is the offset control parameter.

When the leakage rate increases, the imaginary part of the effective refractive index increases. Kramer-Kronig relations dictate that the real part of the index has to decrease in this case. If the optical antenna would be used for beamforming, the phase profile of the emitted beam is very important, and to maintain a collimated beam with a flat phase front it is important to keep the real part of the effective refractive index of the leaky mode constant over the entire length of the antenna. To facilitate this, one has to vary the w_{core} together with the relative offset offsetᵣₑₗ to maintain a constant real part of the effective refractive index of the mode. This approach can control the leakage rate precisely from a lossless waveguide to a highly radiative structure with a high leakage rate, and at the same time keep the real part of the propagation constant of the waveguide constant to obtain a collimated beam with the desired intensity profile. This can be done precisely by tuning the core width and offset together. The variation of the leakage is small for smaller values of the offset, so it has an inherent tolerance for small fabrication variations in the offset of the fin.

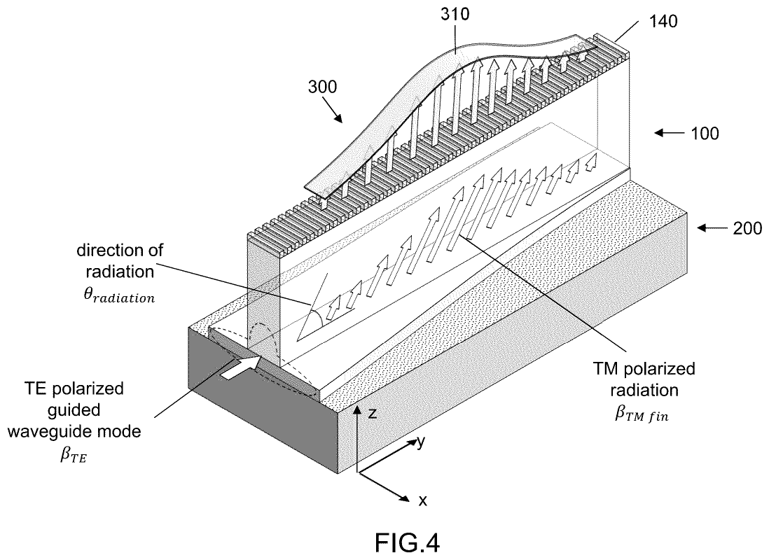

FIG. 4 shows a three-dimensional schematic of an example of an integrated optical antenna comprising a waveguide structure 100 placed over a substrate 200. A height of the waveguide fin is larger than a height of the waveguide core. The waveguide core demonstrates the following aspect ratio: the width of the waveguide core is equal to or larger than twice a height of the waveguide core. The waveguide fin demonstrates the following aspect ratio: the height of the waveguide fin is equal to or larger than twice a width of the waveguide fin. A center axis of the waveguide fin is in offset with respect to a center axis of the waveguide core. Herein, the asymmetry is controlled by varying the cross-section's width of the waveguide core and the placement of the center axis of the waveguide core with respect to center axis of the waveguide fin. The waveguide fin is a straight parallelepiped structure which is provided with a strong periodic grating 140 with constant parameters, i.e., not apodised grating. The grating 140 is placed on top of the fin to couple the leaked radiation out of the optical antenna and into the free space. As shown in the figure, the optical antenna is designed to generate a collimated, uniform, or Gaussian beam profile 300. Herein, this is achieved by controlling the geometry of the optical antenna such that the waveguide fin at one end of the antenna is placed in the center of the waveguide core, i.e., the offset is zero, and at the other end of the antenna, the waveguide fin is placed at the greatest offset, i.e., the offset is maximum. As a result, the leakage rate gradually changes from being very weak at the start of the optical antenna to being very strong at the other end of the optical antenna.

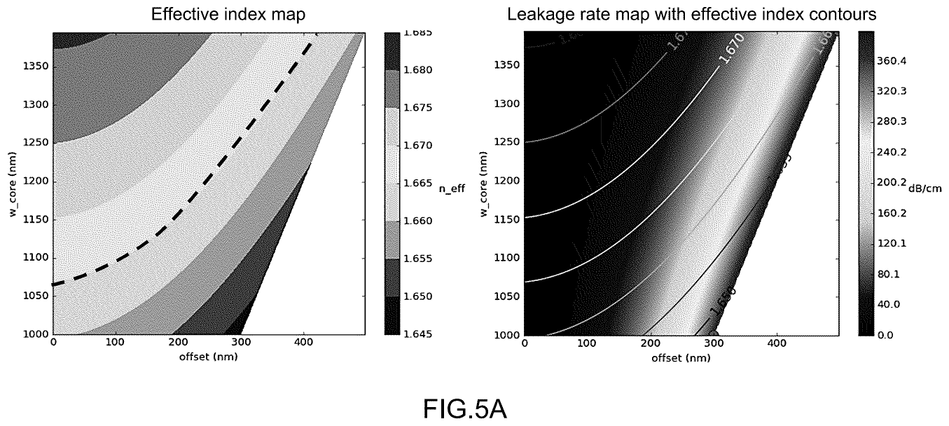

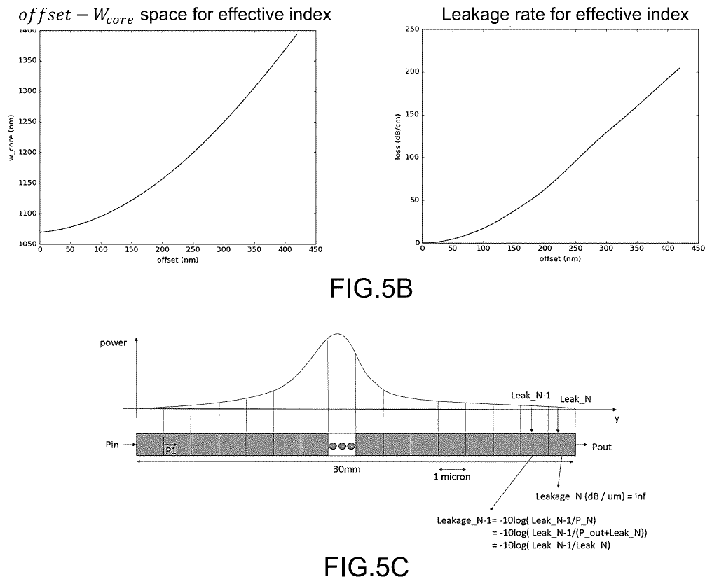

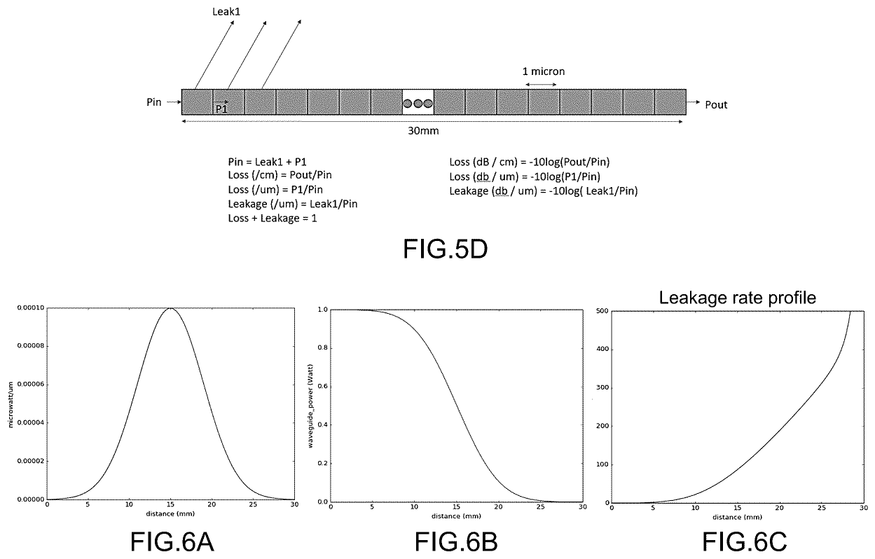

To derive the geometry of the optical antenna and, therefore, the geometry of the waveguide structure, providing an optical beam with a desired profile, e.g., the beam profile of FIG. 4, the relationship between the offset and the w_{core} to the leakage rate and the propagation constant of the waveguide structure need to be mapped. Examples of such maps are shown in FIG. 5A illustrating the effect of the relative offset and core width on the propagation constant, i.e., the real part of the effective refractive index, and the leakage rate, respectively. The gradients on these maps show the sensitivity of the effective index and the leakage rate to change in the offset or the w_{core}, respectively. The maps are obtained from simulating a grid of sample points in an electromagnetic mode solver and interpolating the results. All dimensions are, herein, expressed in nanometer, and the material parameters used in this example correspond to those of stoichiometric silicon nitride around an optical wavelength of 1550 nm. More specifically, the left map shows the effect of offset and the w_{core} on the effective refractive index, i.e., the propagation constant, of the TE waveguide mode, i.e., n_{eff}, and the right map shows their effect on the leakage rate, i.e., the coupling between the TE and the TM waveguide modes. From the left map, it is clear that when the offset increases, the effective index n_{eff} decreases, and, that when the width of the waveguide core increases, the effective index n_{eff} increases. The latter is because of the increasing confinement of light in the high-index waveguide core. From the right map, it is clear that the leakage rate increases strongly with the increase of the offset and with the increase of the core width, with the noticeable difference that the effect of the offset on the leakage rate is much stronger. As mentioned above, to obtain a collimated beam with a desired profile, the propagation constant, i.e., the real part of the effective refractive index, of the waveguide structure should be maintained constant along the length of the antenna. Thus, one way to derive the geometry for the waveguide structure is to derive, from the effective index map, several contours for a respective w_{core} for which the effective index n_{eff}=const remains constant for any offset. Several such contours are overlaid on top of the leakage rate map. Following any of these contours allows designing an optical antenna with a desired leakage rate and with a constant propagation constant. In other words, these contours can be used as guidelines for designing an optical antenna with the desired optical beam profile. This can be done as follows.

First, a constant function is fitted to the offset−w_{core} space the left map to derive a contour for the selected reflective index, for example, the contour shown with the dotted line for n_{eff}=1.665 in FIG. 5A. Similarly, a constant function is fitted to the offset−w_{core} space on the right map to derive the relationship between the offset and the leakage rate. The resulting fitted functions are shown in FIG. 5B. These two fitted functions provide a complete characterization of the leakage rate in terms of the offset for a constant effective index with a selected value, and in this example for n_{eff}=1.665. From these resulting fitted functions, the required offset and the width of the waveguide core, can be then derived. To do so, the antenna, i.e., the waveguide structure, is segmented into segments of 1 μm length, for example. Then, the offset and the width along the length of the antenna are derived by numerically integrating the required loss for each antenna segment starting from the last segment and all the way to the first segment as shown in FIG. 5C. two functions of the antenna geometry can be determined starting from the required loss profile of the antenna. As shown in FIG. 5C, this means that to obtain a Gaussian beam profile the last segment should have an infinitely strong leakage rate, at least in theory. In other words, nearly all power should already be radiated before reaching the last segment. In such a case, the infinity corresponds to the maximum obtainable leakage rate for a length longer than 1 micron and will have virtually no influence on the obtained power profile at the output. From the obtained leakage rate profile of FIG. 5C, a radiation power profile for each segment of the waveguide structure, i.e., the radiation power of the waveguide fin and the radiation power of the waveguide core, is calculated to obtain the complete radiation profile for the waveguide structure, i.e., the optical antenna, as shown in FIG. 5D. Finally, for each segment, the leakage rate of FIG. 5B is transformed to the required dB/cm value.

Following this design methodology, a Gaussian beam profile with a beam waist of 20 mm for an optical antenna with a length of 30 mm as shown in FIG. 6A can be obtained with a radiation power profile as shown in FIG. 6B and a leakage rate profile as shown in FIG. 6C, with the radiation power profile and leakage profiles derived as described above with reference to FIG. 5A to FIG. 5D. As it can be seen in FIG. 6C, the first segment of the antenna has a leakage rate of 0 while the last segment of the antenna has a leakage rate reaching well above 500, resulting in infinite dB/cm. Once, the profile of the leakage rate is derived, the antenna geometry for each antenna segment is calculated by mapping the leakage rate profile of FIG. 6C to the fitted contours of FIG. 5B. The result is an antenna configured to generate a collimated, Gaussian optical beam achieved by controlling the leakage rate along the antenna length while keeping the effective index constant and thus enabling wavelength steering. In other words, the designed antenna can be used to form for example a 1D optical phased antenna array with densely packed antennas. As this antenna beam can be steered by adjusting the wavelength of the input light, the thus formed optical phased array can generate an optical beam that can be steered in the x-direction by means of tunable phase shifters and in the y-direction by employing wavelength steering.

The same procedure can be followed to derive the geometry of the waveguide structure for an optical beam with another beam profile by identifying contours in the effective index map and the leakage rate map for the desired beam profile. For example, first the width profile of the waveguide core, i.e., w_{core}(y), is derived for the desired effective index to obtain several contours as above, and, then the derived contours are overlaid on top of the leakage rate map to derive the offset profile offset(y). The geometry of the waveguide structure is then derived by simply following any of these contours.

In some cases, it may be required to obtain an optical beam with no restrictions on its phase profile. This may be the case when the light emitted by the waveguide structure is going to be absorbed very close to its radiating surface. In that case, only the leakage rate needs to be controlled and the width of the waveguide core can be freely chosen, i.e., there is no constraint on the w_{core}. Such an optical function, i.e., no phase sensitivity, could be useful for distributing light to an imager sensor or for pumping pixels in a micro-display.

Once the required geometry is obtained, the optical antenna can be fabricated. The optical antenna as described above can be fabricated using current large-scale lithography techniques. This is possible as only the offset which is the main control parameter in defining the properties of the optical antenna needs to be well controlled. The sidewalls of the waveguide fin do not need to be vertical, but their profile needs to be well controlled and uniform. The high-contrast waveguide fin can be either vertical or tapered outwards, i.e., its cross-section becomes broader, towards the top. As long as this shape is well controlled and reproducible, the optical antenna with the desired geometry can be engineered and fabricated accordingly. Further, fabricating the diffraction grating on top of the waveguide fin with a width of around 2-3 microns requires etching with sufficient quality for a length of 30 mm antenna with good uniformity. However, the fabrication requirements are relaxed as the grating pattern consists of grooves with a constant thickness and period along a single direction.

Advantageously, the antenna can be designed to have a continuous tapered design. Thus, the tolerance to process variations is high. This is also due to the fact that there are no critical features, i.e., small features, in the optical antenna design. Further, the leakage profile can be preserved despite deviation in offset caused by process variations. As shown in the FIG. 5A above process variations are well tolerated. For example, variations within 20 nm from the target offset value can be tolerated.

Advantageously, fabricating the optical antennas using high index contrast material such as silicon or silicon nitride, resulting in optical antennas with a width smaller than 2 microns. This means that an optical phased array with a wide-angle beam steering in the range of a hundred degrees in the x-direction can be fabricated as the optical antennas allow for spacing with a pitch of 3 microns. As detailed above, the optical antennas can be designed to be wavelength dependent allowing a relatively wide steering angle in the both x- and y-directions.

Advantageously, the uniform grating on top of the waveguide fin acts as an independent dispersive element in the design of the optical antenna. The grating does not need to be apodised. The grating can be designed to be very strong, diffracting all radiation power in one diffraction order. For example, the grating can be designed as a blazed grating. Further, as the beam profile is determined by the leakage profile, the beam profile is, thus, independent of the grating strength. This means that the critical patterns for the grating can be patterned independently from the antenna design.

Summarized, the above-described invention enables designing optical antennas capable of emitting a narrow optical beam, thus, allowing creating of a 1D optical phased array with densely packed optical antennas which can be implemented in silicon or silicon nitride photonics. Further, the above-described invention allows for accurate control of the out-of-plane emission during the design of the optical antenna, thus, allowing the designing of optical antennas with the desired beam profile. Furthermore, the above-described invention allows for designing optical antennas capable of generating a collimated beam with a Gaussian profile even with a beam waist of 30 mm or more and a beam projection distance of 100 m or more.

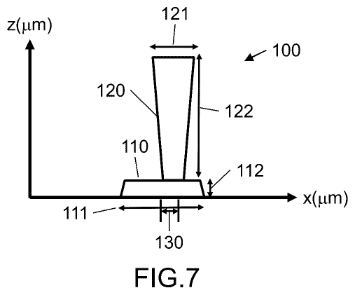

Placing the waveguide fin 120 at an offset 130, i.e., offset, with respect to the waveguide core 110, as shown in FIG. 7, adds an asymmetry to the waveguide structure 100. In this figure, offset 130 is shown as the distance between the center axis of the waveguide core and the waveguide fin. A waveguide structure 100 with such geometry can be fabricated in silicon, Si, or silicon nitride, SiN photonics using current large-scale photolithographic techniques with both the waveguide core 110 and the waveguide fin 120 made of the same material, i.e., Si or SiN, respectively, or materials with a similar refractive index. Alternatively, the waveguide core and the waveguide fin are not made of the material. It is clear from FIG. 7 that the waveguide core does not need to demonstrate a rectangular cross-section in the context of the present disclosure. It is clear from FIG. 7 that the waveguide fin does not need to demonstrate a rectangular cross-section in the context of the present disclosure.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the scope of the claims are therefore intended to be embraced therein.

It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfill the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1.-19. (canceled)

20. An optical antenna comprising a waveguide structure formed on a substrate, the waveguide structure comprising a waveguide core and a waveguide fin intersecting substantially under a right angle,
wherein a height of the waveguide fin is larger than a height of the waveguide core; and
the width of the waveguide core is equal to or larger than twice a height of the waveguide core; and
the height of the waveguide fin is equal to or larger than twice a width of the waveguide fin; and
wherein a center axis of the waveguide fin is off-centered with respect to a center axis of the waveguide core at an offset, thereby forming an optical antenna configured to leak radiation in a radiation direction.

21. The optical antenna according to claim 20, wherein the offset varies along the length of the waveguide core, and
wherein the offset substantially controls the radiation leakage in the radiation direction.

22. The optical antenna according to claim 20, wherein the waveguide core has a substantially rectangular cross-section with a width varying along the length of the waveguide core, and
wherein the variation of the width of the rectangular cross-section of the waveguide core substantially controls the direction of the radiation leakage along the length of the waveguide core.

23. The optical antenna according to claim 20, wherein the waveguide fin has a substantially rectangular cross-section with an aspect ratio higher than the aspect ratio of the cross-section of the waveguide core and a width varying along the length of the waveguide fin, and
wherein the variation of the width of the rectangular cross-section of the waveguide fin substantially controls the direction of the radiation leakage along the length of the waveguide core.

24. The optical antenna according to claim 21, wherein the variation of the width of the rectangular cross-section of the waveguide core and the variation of the offset defines the coupling between a guided mode and a radiation mode of the waveguide structure.

25. The optical antenna according to claim 21, wherein the variation of the width of the rectangular cross-section of the waveguide fin and the variation of the offset defines the coupling between a guided mode and a radiation mode of the waveguide structure.

26. The optical antenna according to claim 20, wherein the control of the leakage rate and the control of the leakage direction along the length of the waveguide core is defined by the variations of any one or combination of the width of the cross-section of the waveguide core, the width of the cross-section of the waveguide fin, and their position relative to one another.

27. The optical antenna according to claim 26, wherein the optical antenna is configured to generate an optical beam with a beam profile defined by the leakage rate and the leakage direction along the length of the waveguide core.

28. The optical antenna according to claim 27, wherein the optical antenna is configured to generate an optical beam with a substantially Gaussian beam profile by varying the leakage rate along the length of the waveguide core.

29. The optical antenna according to claim 28, wherein the optical antenna is configured to generate the optical beam with a collimated and substantially Gaussian beam profile by varying the leakage rate and by maintaining the leakage direction substantially uniform along the length of the waveguide core.

30. The optical antenna according to claim 27, wherein the beam profile along the length of the waveguide core is characterized with a beam waist in the range of centimeters and a beam projection distance in the range of hundreds of meters.

31. The optical antenna according to claim 27, wherein the beam profile is wavelength dependent and wherein the wavelength dependency is controlled by varying any one or combination of the width of the cross-section of the waveguide core, the width of the cross-section of the waveguide fin, and their position relative to one another.

32. The optical antenna according to claim 20, wherein the fin is provided with a diffraction grating, or a refractive optical element configured to couple the radiation into free space.

33. The optical antenna according to claim 32, wherein the diffraction grating is a periodic diffraction grating with a refractive index contrast of above 10%.

34. The optical antenna according to claim 20, wherein the waveguide structure is a dielectric or semiconductor waveguide structure, and
wherein the waveguide core has a refractive index contrast of above 10% with respect to surrounding materials.

35. The optical antenna according to claim 20, wherein the width of the waveguide fin is substantially equal to the height of the waveguide core.

36. The optical antenna according to claim 20, wherein an optical thickness of the waveguide fin is larger than an optical thickness of the waveguide core.

37. An optical phased antenna array comprising a plurality of optical antennas according to claim 20.

38. The optical phase antenna array according to claim 37, wherein the optical antennas are arranged to form a one-dimensional antenna array.
